(19) United States
(12) Patent Application Publication
(10) Pub. No.: US 2024/0305422 A1
(43) Pub. Date: Sep. 12, 2024

(54) REFERENCE SIGNAL CONFIGURATION METHOD AND APPARATUS, AND DEVICE AND STORAGE MEDIUM

(71) Applicant: BEIJING XIAOMI MOBILE SOFTWARE CO., LTD., Beijing (CN)

(72) Inventor: Yang LIU, Beijing (CN)

(73) Assignee: BEIJING XIAOMI MOBILE SOFTWARE CO., LTD., Beijing (CN)

(21) Appl. No.: 18/574,741

(22) PCT Filed: Jun. 30, 2021
(86) PCT No.: PCT/CN2021/103637

§ 371 Date: Dec. 27, 2023

(51) Int. Cl. H04L 5/00

(52) U.S. Cl. CPC H04L 5/005; H04L 5/0035

(57) ABSTRACT

The present application relates to the field of mobile communications. Disclosed are a method and apparatus for configuring a reference signal, and a device and a storage medium. The method includes: receiving, by a terminal device, first information sent by a network device, wherein the first information is used for indicating port association relationships corresponding to two Transmit-Receive Points (TRPs), and the port association relationship is used for reflecting an association relationship between a first reference signal port and a second reference signal.

### CROSS-REFERENCE TO RELATED APPLICATION

The application is a U.S. national phase application of International Application No. PCT/CN2021/103637 filed on Jun. 30, 2021, the entire content of which is incorporated herein by reference for all purposes.

### TECHNICAL FIELD

The present application relates to the field of mobile communication, and in particular, to a method and apparatus for configuring a reference signal, a device, and storage medium.

### BACKGROUND

The terminal device sends a Phase Tracking Reference Signal (PT-RS) to the network device, and the network device estimates the Common Phase Error (CPE) of the carrier according to the PT-RS, and compensates the CPE, thereby improving the service quality. Each PT-RS port may be associated with one Demodulation Reference Signal (DMRS) port. By indicating to the terminal device the relationship between the PT-RS port and the DMRS port of the network device, the network device can receive the PT-RS sent by the terminal device through the DMRS port associated with the PT-RS port.

The 3rd Generation Partnership Project (3GPP) proposed a repeated transmission technology based on multiple Transmit-Receive Points (TRPs) in the 5G New Radio (NR) system. One network device can transmit the message based on multi-TRP.

### SUMMARY

Embodiments of the present application provide a method and apparatus for configuring a reference signal, a device, and a storage medium, which can configure the association relationship between the PT-RS port and the DMRS port for multi-TRP. The described technical solutions are as follows.

According to an aspect of the present application, a method for configuring a reference signal is provided, the method including:
receiving, by a terminal device, first information sent by a network device, where the first information is used for indicating port association relationships corresponding to two TRPs, and the port association relationship is used for reflecting an association relationship between a first reference signal port and a second reference signal port.

According to another aspect of the present application, a method for configuring a reference signal is provided, the method including:
sending, by a network device, first information to a terminal device, where the first information is used for indicating port association relationships corresponding to two TRPs, and the port association relationship is used for reflecting an association relationship between a first reference signal port and a second reference signal port.

According to another aspect of the present application, an apparatus for configuring a reference signal is provided, and the apparatus includes:
a receiving module, configured to receive first information sent by a network device, where the first information is used for indicating port association relationships corresponding to two TRPs, and the port association relationship is used for reflecting an association relationship between a first reference signal port and a second reference signal port.

According to another aspect of the present application, an apparatus for configuring a reference signal is provided, and the apparatus includes:
a sending module, configured to send first information to a terminal device, where the first information is used for indicating port association relationships corresponding to two TRPs, and the port association relationship is used for reflecting an association relationship between a first reference signal port and a second reference signal port.

According to another aspect of the present application, a terminal device is provided, and the terminal device includes: a processor and a transceiver connected to the processor; where
the transceiver is configured to receive first information sent by a network device, the first information is used for indicating port association relationships corresponding to two TRPs, and the port association relationship is used for reflecting an association relationship between a first reference signal port and a second reference signal port.

According to another aspect of the present application, a network device is provided, and the network device includes: a processor and a transceiver connected to the processor; where
the transceiver is configured to send first information to a terminal device, where the first information is used for indicating port association relationships corresponding to two TRPs, and the port association relationship is used for reflecting an association relationship between a first reference signal port and a second reference signal port.

According to another aspect of the present application, a non-transitory computer-readable storage medium is provided, where executable instructions are stored in the readable storage medium, and the executable instructions are loaded and executed by a processor to implement the method for configuring a reference signal in the above-mentioned aspects.

According to another aspect of the embodiments of the present application, a chip is provided, the chip includes a programmable logic circuit and/or program instructions, and when the chip is run on a computer device, it is used to implement the method for configuring a reference signal in the above-mentioned aspects.

According to another aspect of the present application, a computer program product is provided. When the computer program product runs on a processor of a computer device, the computer device executes the method for configuring a reference signal in the above-mentioned aspects.

The technical solutions provided by the embodiments of the present application at least include the following beneficial effects.

The association relationships between the first reference signal port and the second reference signal port can be configured for multi-TRP through the first information, the first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

### BRIEF DESCRIPTION OF THE DRAWINGS

In order to more clearly illustrate the technical solutions in the embodiments of the present application, the drawings that need to be used in the description of the embodiments will be briefly introduced below. Obviously, the drawings in the following description are only some embodiments of the present application. For those skilled in the art, other drawings can also be obtained based on these drawings without creative effort.

FIG. 1 is a schematic diagram of a physical resource block provided by some embodiments of the present application;

FIG. 2 is a schematic diagram of another physical resource block provided by some embodiments of the present application;

FIG. 3 is a schematic diagram of repeated transmission of PUSCH between slots in an uplink channel transmission method provided by some embodiments of the present application;

FIG. 4 is a schematic diagram of repeated transmission of PUSCH between slots in an uplink channel transmission method provided by some embodiments of the present application;

FIG. 5 is a schematic diagram of repeated transmission of PUSCH between slots in an uplink channel transmission method provided by some embodiments of the present application;

FIG. 6 is a schematic diagram of a system architecture provided by some embodiments of the present application;

FIG. 7 is a flowchart of a method for configuring a reference signal provided by some embodiments of the present application;

FIG. 8 is a flowchart of a method for configuring a reference signal provided by some embodiments of the present application;

FIG. 9 is a flowchart of a method for configuring a reference signal provided by some embodiments of the present application;

FIG. 10 is a flowchart of a method for configuring a reference signal provided by some embodiments of the present application;

FIG. 11 is a flowchart of a method for configuring a reference signal provided by some embodiments of the present application;

FIG. 12 is a flowchart of a method for configuring a reference signal provided by some embodiments of the present application;

FIG. 13 is a flowchart of a method for configuring a reference signal provided by some embodiments of the present application;

FIG. 14 is a flowchart of a method for configuring a reference signal provided by some embodiments of the present application;

FIG. 15 is a flowchart of a method for configuring a reference signal provided by some embodiments of the present application;

FIG. 16 is a structural block diagram of an apparatus for configuring a reference signal provided by some embodiments of the present application;

FIG. 17 is a structural block diagram of an apparatus for configuring a reference signal provided by some embodiments of the present application;

FIG. 18 is a schematic structural diagram of a communication device provided by some embodiments of the present application.

### DETAILED DESCRIPTION

In order to make the purpose, technical solutions and advantages of the application clearer, the following will further describe the implementations of the present application in detail in conjunction with the accompanying drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments of the present disclosure. Instead, they are merely examples of apparatuses and methods consistent with some aspects related to the embodiments of the present disclosure as recited in the appended claims.

The terms used in the embodiments of the present disclosure are for the purpose of describing particular embodiments only and are not intended to limit the embodiments of the present disclosure. As used in the embodiments of the present disclosure and the appended claims, the singular forms “a/an”, “the”, and “said” are intended to include the plural forms as well, unless the context clearly dictates otherwise. It should also be understood that the term “and/or” as used herein refers to and includes any or all possible combinations of one or more of the associated listed items.

It should be understood that although the terms first, second, third, etc. may be used in the embodiments of the present disclosure to describe various pieces of information, such information should not be limited by these terms. These terms are only used to distinguish the same type of information from each other. For example, the first information may also be referred to as second information, and similarly, the second information may also be referred to as the first information, without departing from the scope of the embodiments of the present disclosure. Depending on the context, the word “if” as used herein can be interpreted as “at the time of” or “when” or “in response to determining”.

First, the Phase Tracking Reference Signal (PT-RS) is introduced.

The operation of the local oscillator circuit in the network device and the terminal device may destroy the orthogonality of individual subcarriers in the Orthogonal Frequency Division Multiplexing (OFDM) system, thereby generating Phase Noise (PN), and then there may be a phase error (Common Phase Error, CPE), which may affect the performance of uplink transmission and downlink transmission. Therefore, the network device needs to compensate for CPE. In 5G NR, the network device can estimate the CPE through the PT-RS signal sent by the terminal device, so as to perform compensation calculations on the CPE and compensate the CPE to achieve enhanced signal coverage and improve signal quality. The PT-RS is a reference signal specific to the terminal device and configured by the network device to the terminal device. The PT-RS can be used to estimate the CPE introduced by the local oscillator circuit in the network device and the terminal device.

Since the CPE generated by PN has the same frequency characteristics in the entire frequency band and has random phase characteristics in time, the PT-RS is designed to be relatively sparse in the frequency domain and have relatively high density in the time domain. The mapping of the PT-RS in the frequency domain can adopt uniform distribution or centralized distribution. When the uniform distribution is adopted, one carrier may be selected in each Physical Resource Block (PRB) or every several PRBs for mapping of the PT-RS. When the centralized distribution is adopted, the PT-RS may be mapped to a plurality of adjacent subcarriers in a centralized manner. The adoption of the uniform distribution can ensure that the PT-RS ports correspond to the DMRS ports one by one, and the corresponding phase noise compensation algorithm is also relatively simple. The adoption of the centralized distribution can not only compensate for the CPE, but also further compensate for inter-carrier interference, but the corresponding PT-RS transmission mode and phase noise compensation algorithm are more complicated. In 5G NR, the uniform distribution manner is adopted, and each PT-RS port is supported to be associated with one DMRS port. The embodiments of the present application are mainly described in a way that the mapping of the PT-RS in the frequency domain adopts the uniform distribution. Both the PT-RS and the DMRS are reference signals, the PT-RS may be regarded as an extension of the DMRS, and the data transmission of the PT-RS port is implemented based on the DMRS port associated with the PT-RS.

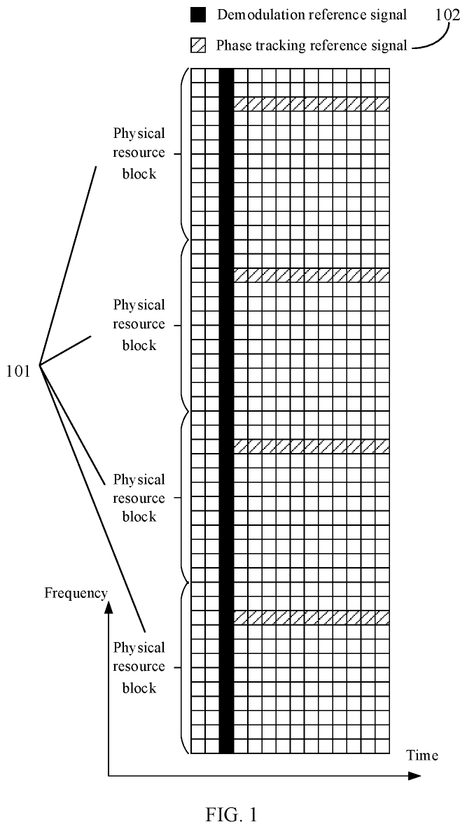

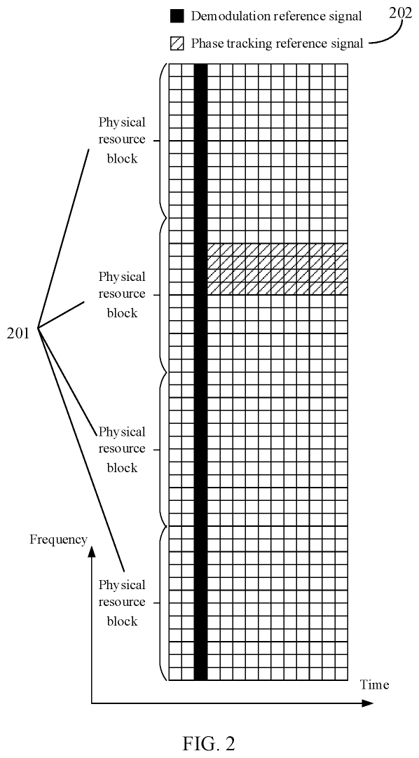

For example, FIG. 1 is a schematic diagram of a physical resource block provided by some embodiments of the present application. As shown in FIG. 1, in each PRB 101, there is one carrier used for mapping of PT-RS 102, and the PT-RS 102 adopts the uniform distribution manner at this time. FIG. 2 is a schematic diagram of another physical resource block provided by some embodiments of the present application. As shown in FIG. 2, in one PRB 201 among the plurality of PRBs 201, there are a plurality of adjacent carriers used for mapping of PT-RS 202, and the PT-RS 202 adopts the centralized distribution manner at this time.

The number of the PT-RS ports is related to the number of phase noise sources. When there are a plurality of independent phase noise sources, each phase noise source requires one PT-RS port to realize the phase estimation of this phase noise source. The scenario of the plurality of PT-RS ports is mainly applied in the multi-point coordinated mode. The phase noise sources of individual coordinated points are independent of each other. Therefore, one PT-RS port needs to be configured for each coordinated point. For uplink transmission, considering partial coherent or non-coherent transmission in the uplink, a plurality of PT-RS ports are also required in the non-coordinated scenarios. In Release 15 (R15), one downlink PT-RS port and two uplink PT-RS ports are supported. Whether to transmit the PT-RS in the uplink is also controlled through the configuration of the high layer parameter. If phaseTrackingRS is not configured for the terminal device in the DMRS-UplinkConfig of the high layer parameter, the terminal device will not transmit the PT-RS during uplink.

The PT-RS can be used as an extension of the demodulation pilot, and is configured to be transmitted simultaneously with user data within the user's scheduling bandwidth. At this point, the PT-RS can be used for both phase estimation and data demodulation. For multi-stream transmission scenarios, if all data streams experience the same phase noise source, the PT-RS can be transmitted on any data stream. That is, the PT-RS port can be associated with any DMRS port, and the PT-RS port and its associated DMRS port use the same precoding. The phase noise estimated based on the PT-RS can be used for phase noise compensation of the remaining data stream(s). It is stipulated in 5G NR that QCL-TypeA (QUASI CO-LOCATION TypeA) and QCL-TypeD are satisfied between the PT-RS port and its associated DMRS port.

In order to ensure the transmission performance of the PT-RS, it can be mapped to the data stream with the best channel quality for transmission. According to the 5G NR protocol, during downlink transmission, if the terminal device only schedules one codeword, the PT-RS port is associated with the DMRS port with the lowest index value; if the terminal device schedules two codewords, the PT-RS port is associated with the DMRS port with the lowest index value and corresponding to the codeword with the highest Modulation and Coding Scheme (MCS); if the two codewords are the same, the PT-RS port is associated with the DMRS port with the lowest index value and corresponding to the first codeword. Since the terminal device can feed back LI, which indicates the precoding used by the strongest layer, the network device can ensure that the PT-RS is transmitted on the strongest transport layer. During uplink transmission, since the uplink channel status information is known by the network device, the association between the PT-RS port and the DMRS port is indicated by Downlink Control Information (DCI). In particular, for codebook-based partial coherent and non-coherent transmission, the structure of its uplink codebook implies the assumption that the Sounding Reference Signal (SRS) port 0 and the SRS port 2 have the same phase noise, while the SRS port 1 and the SRS port 3 have the same phase noise. Therefore, it is stipulated in the protocol that the PT-RS port 0 is associated with the DMRS port transmitted on the SRS port 0 and the SRS port 2, and the PT-RS port 1 is associated with the DMRS port transmitted on the SRS port 1 and the SRS port 3.

Afterwards, multiple Transmit-Receive Points (TRPs) of the network device is introduced.

In the R16 research stage, a multi-point coordinated transmission technology for communication based on multi-TRP of the network device and multi-antenna panel (panel) of the terminal device is proposed, and the transmission enhancement of Physical Downlink Shared Channel (PDSCH) is realized. Based on multi-TRP and multi-panel, it can improve coverage of the cell edge, provide more balanced service quality in the service area, and can coordinate data transmission among multi-TRP or multi-panel by using different manners. From the perspective of network form, network deployment with a large number of distributed access points (TRPs) and centralized baseband processing is more conducive to providing a balanced user experience rate, and significantly reducing the delay and signaling overhead caused by handover. Using the coordination among multi-TRP and multi-panel can realize channel transmission/reception from multiple beams with multiple angles, which can better overcome various occlusion/blocking effects and ensure the robustness of link connections, thereby improving the transmission quality and meeting the reliability requirement in the Ultra Reliable and Low Latency Communication (URLLC) scenario.

Since the data transmission includes the scheduling feedback of the uplink and downlink channels, in URLLC research, only enhancing the downlink data channel cannot guarantee the overall transmission performance of the network. Therefore, in the R17 research, the Physical Downlink Control Channel (PDCCH), Physical Uplink Control Channel (PUCCH) and Physical Uplink Shared Channel (PUSCH) are continued to be enhanced.

The uplink channel enhancement scheme based on multi-TRP is mainly based on the PUCCH/PUSCH repeated transmission scheme of R16. The embodiment of the present application mainly introduces the PUSCH repeated transmission scheme. The uplink transmission scheme of the PUSCH includes two schemes: codebook-based uplink transmission and non-codebook uplink transmission. For PUSCH transmissions facing different TRPs, the direction information may be indicated through the SRS Resource Indicator (SRI) field in the DCI signaling. At present, the Time-Division Multiplexing (TDM) repetition mode of PUSCH mainly includes PUSCH repetition type A and PUSCH repetition type B.

### (1) PUSCH Repetition Type a Transmission Mode.

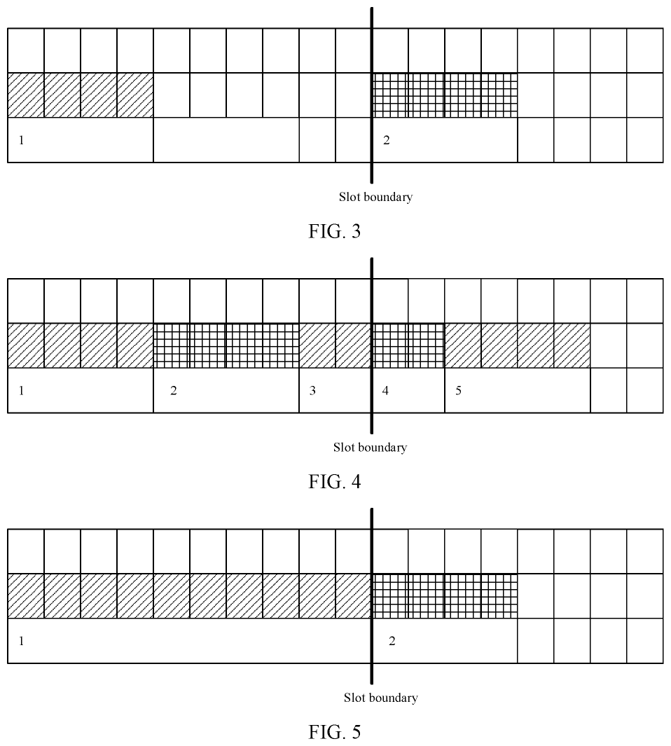

Repeated transmission between slots is configured through Radio Resource Control (RRC) signaling, and the same Transport Block (TB) is repeatedly transmitted at a plurality of transmission occasions. This transmission type is mainly applied at the cell edge, so the number of transmission layers is limited to unilateral transmission at the same time. One PUSCH is transmitted in consecutive K slots, that is, K transmission occasions, the transmission is started from the S-th symbol in the starting slot, and each transmission occasion lasts for L symbols, and S+L does not exceed the slot boundary. For example, as shown in FIG. 3, S is equal to 1, and L is equal to 4. The terminal device performs the first repeated transmission in the first symbol to the fourth symbol of the first slot, and performs the second repeated transmission in the first symbol to the fourth symbol of the second slot.

### (2) PUSCH Repetition Type B Transmission Mode.

This transmission type can achieve continuous (back to back) transmission for the same TB, and can cross the slot boundary. This transmission type does not limit the number of transmission layers, and can support data transmission of uplink layers 1-4. In the time domain, one PUSCH starts transmission on the S-th symbol in the starting slot, and sends K transmission occasions (nominal repetition) continuously, where each transmission occasion occupies L symbols continuously (back-to-back), and the transmission of S+L can cross the slot boundary.

As shown in FIG. 4, when S is equal to 1 and L is equal to 4, the terminal device is configured to perform repeated transmission of the uplink channel 4 times. The terminal device performs the first repeated transmission in the first symbol to the fourth symbol of the first slot, and performs the second repeated transmission in the fifth symbol to the eighth symbol of the first slot. According to the configuration information, 4 symbols of the third repeated transmission cross the slot boundary of the slot, thus the third repeated transmission is divided into two repeated transmissions, the third repeated transmission is performed in the ninth symbol to the tenth symbol of the first slot, and the fourth repeated transmission is performed in the first symbol to the second symbol of the second slot. The fifth repeated transmission is performed from the third symbol to the sixth symbol of the second slot. That is, the terminal device actually performs 5 repeated transmissions, and the same data is sent in each repeated transmission.

As shown in FIG. 5, when S is equal to 1 and L is equal to 14, the terminal device is configured to perform one repeated transmission of the uplink channel. Since the length of one slot is 10 symbols, and each transmission occasion occupies 14 symbols, the 14 symbols of the first repeated transmission will cross the slot boundary, and the first repeated transmission is divided into two repeated transmissions, the first repeated transmission is performed in the first symbol to the tenth symbol of the first slot, and the second repeated transmission is performed in the first symbol to the fourth symbol of the second slot. That is, the terminal device actually performs two repeated transmissions, and the same data is sent in each repeated transmission.

For PUSCH based on multi-TRP transmission, the terminal further obtains space diversity gain and improves transmission reliability by jointly sending the unified TB of PUSCH for different TRPs. For different transmission occasions, the transmission corresponding to different beam directions can be mapped. The following are three typical schemes.

Scheme a: cyclic mapping. Two beam directions are cyclically mapped to a plurality of configured transmission occasions in sequence. For example, when performing 4 repeated transmissions, the pattern of beam direction mapping may be #1 #2 #1 #2, where #1 corresponds to the first beam direction, and #2 corresponds to the second beam direction.

Scheme b: sequential mapping. The two beam directions are continuously and cyclically mapped to a plurality of configured transmission occasions. For example, when performing 4 repeated transmissions, the pattern of beam direction mapping may be #1 #1 #2 #2; for more than 4 repeated transmissions, the pattern is repeated, for example, for 8 repeated transmissions, the pattern of beam direction mapping may be #1 #1 #2 #2 #1 #1 #2 #2.

Scheme c: half-half mapping. The two beam directions are continuously mapped to a plurality of configured transmission occasions. For example, when performing 8 repeated transmissions, the pattern of beam direction mapping may be #1 #1 #1 #1 #2 #2 #2 #2.

In the above scenario of multi-TRP, further discussion and research are needed for the configuration of the PT-RS. The method provided in the embodiment of the present application can configure the association relationships between the PT-RS port and the DMRS port for multi-TRP.

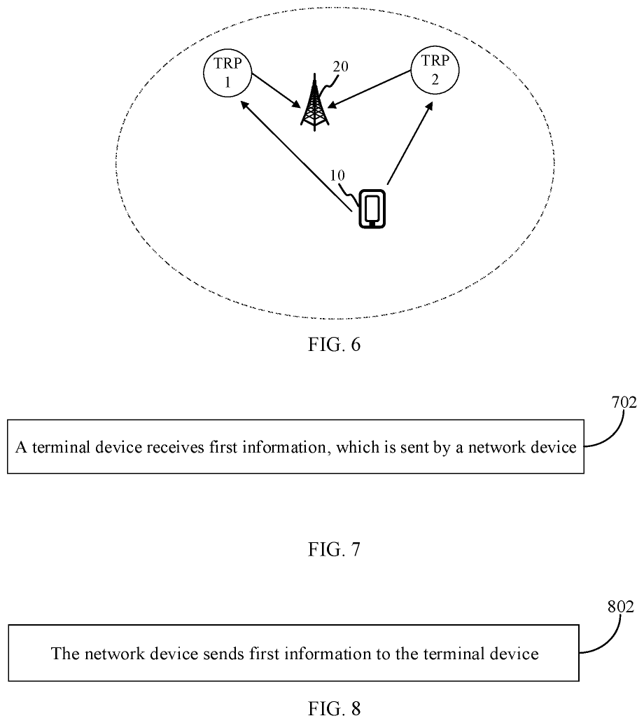

FIG. 6 is a schematic diagram of a system architecture provided by an embodiment of the present application. The system architecture may include: a terminal device 10 and a network device 20.

The number of the terminal devices 10 is generally multiple, and one or more terminal devices 10 may be distributed in a cell managed by each network device 20. The terminal device 10 may include various handheld devices with wireless communication functions, vehicle-mounted devices, wearable devices, computing devices or other processing devices connected to wireless modems, as well as various forms of User Equipment (UE), Mobile Station (MS) and so on. For convenience of description, in the embodiments of the present application, the above-mentioned devices are collectively referred to as terminal devices.

The network device 20 is an apparatus deployed in an access network to provide a wireless communication function for the terminal device 10. The network device 20 may include various forms of macro base stations, micro base stations, relay stations, access points and so on. In systems using different radio access technologies, the names of devices with network device functions may be different. For example, in 5G NR systems, they are called gNodeB or gNB. The term “network device” may change as communications technology evolves. For the convenience of description, in the embodiments of the present application, the above-mentioned apparatuses that provide the wireless communication function for the terminal device 10 are collectively referred to as network devices.

For example, one network device 20 is deployed with multi-TRP, for example, the network device 20 corresponds to TRP1 and TRP2. The network device 20 receives the repeated transmission of the uplink channel sent by the terminal device through multi-TRP.

The “5G NR system” in the embodiments of the present disclosure may also be called a 5G system or an NR system, but those skilled in the art can understand its meaning. The technical solutions described in the embodiments of the present disclosure can be applied to the 5G NR system, and can also be applied to the subsequent evolution system of the 5G NR system.

FIG. 7 shows a flowchart of a method for configuring a reference signal provided by an embodiment of the present application. FIG. 7 exemplifies that the method is applied to the terminal device in the communication system shown in FIG. 6. The method includes the following steps.

In step 702: the terminal device receives first information sent by the network device.

The first information is used for indicating port association relationships corresponding to two TRPs, and the port association relationship is used for reflecting an association relationship between a first reference signal port and a second reference signal port. The first information is configured by the network device for the terminal device. The first reference signal port is a port for transmitting a first reference signal, and the second reference signal port is a port for transmitting a second reference signal. In some possible implementation manners, if the first reference signal and/or the second reference signal are respectively sent through multi-TRP, the first information may be used for indicating the port association relationships corresponding to the multi-TRP.

Optionally, the first reference signal is a PT-RS. Optionally, the second reference signal is DMRS. Optionally, the first information is DCI. The two TRPs are TRPs corresponding to the network device connected to the terminal device. One second reference signal port in each TRP is associated with one first reference signal port for implementing transmission of the PT-RS. Each TRP corresponds to one or two PT-RS ports.

Optionally, the first information includes two indication fields, and each indication field is used for indicating an association relationship between the first signal port and the second signal port. The terminal device can respectively determine the port association relationships corresponding to the two TRPs according to the indications of the two indication fields.

Optionally, the first information includes one indication field, and the terminal device can respectively or simultaneously determine the port association relationships corresponding to two TRPs according to the indication of the one indication field.

To sum up, the method provided in this embodiment can configure the association relationships between the first reference signal port and the second reference signal port for multi-TRP through the first information. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

FIG. 8 shows a flowchart of a method for configuring a reference signal provided by an embodiment of the present application. FIG. 8 exemplifies that the method is applied to the network device in the communication system shown in FIG. 6. The method includes the following steps.

In step 802: the network device sends first information to the terminal device.

The first information is used for indicating the port association relationships corresponding to two TRPs, and port association relationship is used for reflecting an association relationship between a first reference signal port and a second reference signal port. The first information is configured by the network device for the terminal device. The first reference signal port is a port for transmitting a first reference signal, and the second reference signal port is a port for transmitting a second reference signal. In some possible implementation manners, if the first reference signal and/or the second reference signal are respectively sent through multi-TRP, the first information may be used for indicating the port association relationships corresponding to the multi-TRP.

Optionally, the first reference signal is a PT-RS. Optionally, the second reference signal is a DMRS. Optionally, the first information is DCI. The two TRPs are TRPs corresponding to the network device connected to the terminal device. One second reference signal port in each TRP may be associated with one first reference signal port, so as to implement transmission of the PT-RS. Each TRP corresponds to one or two PT-RS ports.

Optionally, the first information includes two indication fields, and each indication field is used for indicating an association relationship between the first signal port and the second signal port. The terminal device can respectively determine the port association relationships corresponding to the two TRPs according to the indications of the two indication fields.

Optionally, the first information includes one indication field, and the terminal device can respectively or simultaneously determine the port association relationships corresponding to two TRPs according to the indication of the one indication field.

To sum up, the method provided in this embodiment can configure the association relationships between the first reference signal port and the second reference signal port for multi-TRP through the first information. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

Optionally, the network device can indicate the port association relationships corresponding to the two TRPs by sending different first information to the terminal device. The first type: the first information has two indication fields.

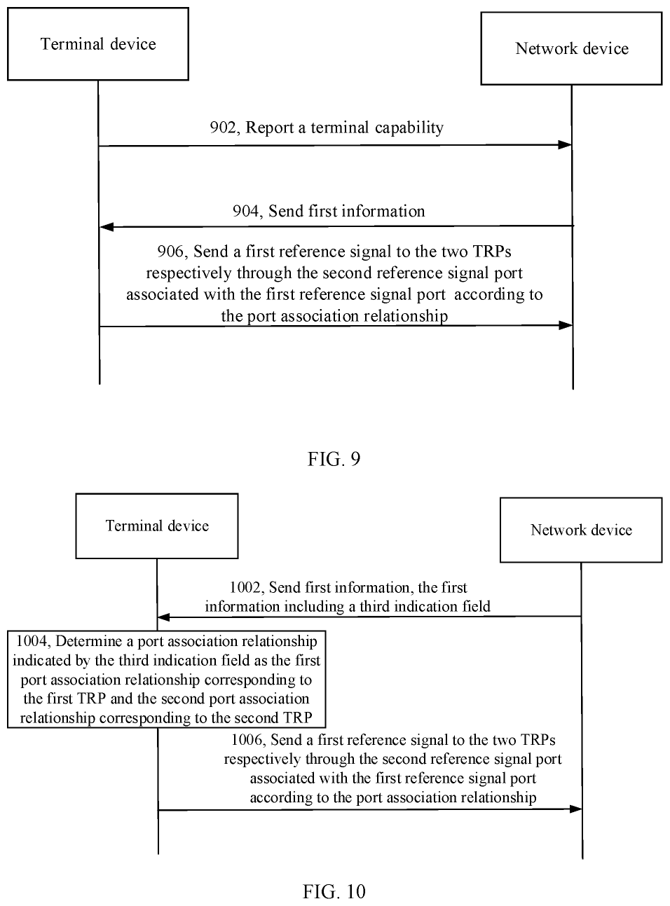

FIG. 9 shows a flowchart of a method for configuring a reference signal provided by an embodiment of the present application. FIG. 9 exemplifies that the method is applied to the communication system shown in FIG. 6. The method includes the following steps.

In step 902: the terminal device reports a terminal capability to the network device.

The terminal capability is used for indicating whether the terminal device supports a capability of being configured with a second indication field. Alternatively, the terminal capability is used for indicating whether the terminal device supports a capability of being configured with two indication fields. Alternatively, the terminal capability is used for indicating whether the terminal device has a capability of parsing the first information of two indication fields. Alternatively, the terminal capability is used for indicating whether the terminal device has a capability of parsing the second indication field. Optionally, the first information is DCI. The two indication fields are used for indicating the association relationship between the first reference signal port and the second reference signal port in the TRP corresponding to the network device. Both the first reference signal and the second reference signal are reference signals, for example, the first reference signal is a PT-RS, and for another example, the second reference signal is a DMRS. The first reference signal is transmitted through the second reference signal port associated with the first reference signal port.

Optionally, when the terminal device joins the cell provided by the network device, it may report the terminal capability to the network device. The terminal capability is preset or configured on the terminal device when it leaves the factory.

In step 904: the network device sends first information to the terminal device.

In some implementation manners, in response to determining that the terminal device supports the capability of being configured with the second indication field, the network device may configure the terminal device with first information including the first indication field and the second indication field. In some other implementation manners, the network device configures the terminal device with the first information including the first indication field and the second indication field, regardless of whether the terminal capability sent by the terminal device has been received. That is, there is no causal relationship or execution sequence relationship between the following two steps: the terminal device reporting the terminal capability to the network device, and the network device sending the first information to the terminal device.

The first information is used for indicating the port association relationships corresponding to the two TRPs. When the network device configures the parameter UL-PTRS-present for the terminal device, the terminal device needs to transmit PT-RS in the uplink. The network device may indicate the port association relationship corresponding to the TRP through the first information. The first indication field and the second indication field may be PTRS-DMRS association in DCI0_1 or DCI0_2. The port association relationship is used for reflecting the association relationship between the first reference signal port and the second reference signal port. The two TRPs include a first TRP and a second TRP. The first indication field is used for indicating the first port association relationship corresponding to the first TRP, and the second indication field is used for indicating the second port association relationship corresponding to the second TRP. The corresponding relationship between the first indication field and the first TRP is configured or predefined, and the corresponding relationship between the second indication field and the second TRP is configured or predefined. Optionally, the terminal device supports a maximum number of data layers greater than 2 when performing uplink sending.

Each of the two TRPs corresponds to one or two PT-RS ports. Therefore, both the first port association relationship and the second port association relationship are used for indicating the association relationship between a single first reference signal port (such as PT-RS port 0 or PT-RS port 1) and the second reference signal port. Or, both the first port association relationship and the second port association relationship are used for indicating the association relationship between the dual first reference signal ports (such as PT-RS port 0 and PT-RS port 1) and the second reference signal port. As an example, Table 1 shows the relationship between the value of the indication field and the indicated port association relationship in the case of the single PT-RS port.

TABLE 1

| value | DMRS port |
|---|---|
| 0 | Configured to associate with DMRS port 1 |
| 1 | Configured to associate with DMRS port 2 |
| 2 | Configured to associate with DMRS port 3 |
| 3 | Configured to associate with DMRS port 4 |

As shown in Table 1, when the value in the first indication field or the second indication field is 0, it indicates that PT-RS port 0 is associated with the first DMRS port in the corresponding TRP, when the value in the first indication field or the second indication field is 1, it indicates that PT-RS port 0 is associated with the second DMRS port in the corresponding TRP, when the value in the first indication field or the second indication field is 2, it indicates that PT-RS port 0 is associated with the third DMRS port in the corresponding TRP, when the value in the first indication field or the second indication field is 3, it indicates that PT-RS port 0 is associated with the fourth DMRS port in the corresponding TRP. The foregoing association manners are only for illustration, and are not intended to limit the implementation manners in the embodiments of the present disclosure. Table 2 shows the relationship between the indication field and the indicated

port association in the case of the dual PT-RS ports.

TABLE 2

| Value of | | Value | |
|---|---|---|---|
| MSB | DMRS port | of LSB | DMRS port |
| 0 | PT-RS port 0 is associated with | 0 | PT-RS port 1 is associated with the first |
| | the first DMRS port in the first | | DMRS port in the second group of |
| | group of DMRS ports | | DMRS ports |
| 1 | PT-RS port 0 is associated with | 1 | PT-RS port 1 is associated with the |
| | the second DMRS port in the | | second DMRS port in the second group |
| | first group of DMRS ports | | of DMRS ports |

As shown in Table 2, in the case that the TRP corresponds to two PT-RS ports, the DMRS ports in the TRP may be divided into two groups. When maxNrofPorts in the high layer parameter PTRS-UplinkConfig is configured as “n2”, it indicates that the number of PT-RS ports corresponding to the TRP is the largest. At this time, the network side may divide the DMRS ports into two groups through the SRS resource, so as to establish an association relationship with the PT-RS ports respectively. For example, there are four DMRS ports in the TRP, namely DMRS port 0, DMRS port 1, DMRS port 2, and DMRS port 3. DMRS port 0 and DMRS port 2 are the first group, and DMRS port 1 and DMRS port 3 are the second group. When the value of the Most Significant Bit (MSB) in the first indication field or the second indication field is 0, it indicates that the PT-RS port is associated with the first DMRS port (DMRS port 0) in the first group of DMRS ports in the corresponding TRP. When the Least Significant Bit (LSB) in the first indication field or the second indication field is 1, it indicates that the PT-RS port is associated with the second DMRS port (DMRS port 3) in the second group of DMRS ports in the corresponding TRP.

Optionally, the network device may also send second information to the terminal device, where the second information is used for indicating that the first information includes two indication fields. The second information is RRC information.

In step 906: the terminal device sends a first reference signal to the two TRPs respectively according to the port association relationships.

When the terminal device transmits the PT-RS to the first TRP in the uplink, it may use the DMRS port associated with the PT-RS port corresponding to the first TRP. When the terminal device transmits the PT-RS to the second TRP in the uplink, it may use the DMRS port associated with the PT-RS port corresponding to the second TRP.

In some possible implementation manners, “two” in all the embodiments of the present disclosure is not a closed limitation, that is, it may include two or more TRPs, two or more ports, which will not be repeated here. Meanwhile, in other embodiments of the present disclosure, “two TRPs” or “two ports” may also be considered to refer to two or more than two.

To sum up, the method provided in this embodiment can configure the association relationships between the first reference signal port and the second reference signal port for multi-TRP through the first indication field and the second indication field of the first information. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance. In addition, the terminal device can actively report the terminal capability to the network device, so that the network device can conveniently determine whether the terminal device supports being configured with the second indication field.

The second type: the first information has one indication field. Specifically, it includes the following situations:

(1) Using one indication field to simultaneously indicate the port association relationships corresponding to two TRPs.

FIG. 10 shows a flowchart of a method for configuring a reference signal provided by an embodiment of the present application. FIG. 10 exemplifies that the method is applied to the communication system shown in FIG. 6. The method includes the following steps.

In step 1002: the network device sends first information to the terminal device, where the first information includes a third indication field.

The third indication field is used for determining a first port association relationship corresponding to the first TRP and a second port association relationship corresponding to the second TRP. The third indication field is used for indicating the port corresponding relationships corresponding to the two TRPs by using the same indication field. Optionally, the first information is DCI. In the first information, except for the third indication field, there is no other indication field for indicating the port association relationship. The third indication field may be understood as the above-mentioned first indication field, specifically, the third indication field is the same as or different from the above-mentioned first indication field or the second indication field (different functions). The third indication field is similar to the first indication field or the second indication field, so the cost of developing the third indication field is relatively low.

In step 1004: the terminal device determines a port association relationship indicated by the third indication field as the first port association relationship corresponding to the first TRP and the second port association relationship corresponding to the second TRP.

The first port association relationship is the same as the second port association relationship. The third indication field can indicate the first port association relationship corresponding to the first TRP and the second port association relationship corresponding to the second TRP through the above value or MSB, LSB. For specific indication rules, reference may be made to the foregoing embodiments, and the present application does not repeat them here. Optionally, codepoints also exist in the third indication field, and the terminal device can determine the first port association relationship corresponding to the first TRP and the second port association relationship corresponding to the second TRP according to the codepoints. For example, the DMRS ports in the first TRP and the second TRP are divided into two groups. When the codepoint is 0, it is used for indicating that the PT-RS ports in the first TRP and the second TRP are associated with PT-RS port 0 in the first group of DMRS ports, when the codepoint is 1, it is used for indicating that the PT-RS ports in the first TRP and the second TRP are associated with PT-RS port 1 in the first group of DMRS ports.

Both the first port association relationship and the second port association relationship are used for indicating the association relationship between a single first reference signal port and a second reference signal port. Or, both the first port association relationship and the second port association relationship are used for indicating the association relationship between the dual first reference signal ports and the second reference signal port.

In step 1006: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

To sum up, the method provided by this embodiment can realize the configuration of the association relationships between the first reference signal port and the second reference signal port for multi-TRP at the same time through the third indication field, the first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

(2) Using one indication field to first indicate the port association relationship corresponding to one TRP, and then determining the port association relationship corresponding to the other TRP according to the determined port association relationship.

FIG. 11 shows a flowchart of a method for configuring a reference signal provided by an embodiment of the present application. FIG. 11 exemplifies that the method is applied to the communication system shown in FIG. 6. The method includes the following steps.

In step 1102: the network device sends first information to the terminal device, where the first information includes a third indication field.

The third indication field is used for determining the first port association relationship corresponding to the first TRP and the second port association relationship corresponding to the second TRP. Optionally, the first information is DCI, and in the first information, except for the third indication field, there is no other indication field for indicating the port association relationship.

In step 1104: the terminal device determines a port association relationship indicated by the third indication field as the first port association relationship corresponding to the first TRP.

In step 1106: the terminal device determines the second port association relationship corresponding to the second TRP according to the first port association relationship and a first predefined relationship.

The first port association relationship is different from the second port association relationship. After determining the first port association relationship, the terminal device uses the first port association relationship as a reference, and can determine the second port association relationship according to the first predefined relationship. The first predefined relationship includes a cyclic relationship (cycling) and other patterns.

For example, in the case of a single PT-RS port, the first port association relationship is that PT-RS port 0 is associated with DMRS port 0, and the second port association relationship determined by the terminal device based on the cycling is that PT-RS port 0 is associated with DMRS port 0. The first port association relationship is that PT-RS port 0 is associated with DMRS port 1, and the second port association relationship determined by the terminal device based on the cycling is that PT-RS port 0 is associated with DMRS port 2. The first port association relationship is that PT-RS port 0 is associated with DMRS port 0, and the second port association relationship determined by the terminal device based on other pattern is that PT-RS port 0 is associated with DMRS port(s) other than DMRS port 0. The first port association relationship is that PT-RS port 0 is associated with DMRS port 0, and the second port association relationship determined by the terminal device based on other pattern is that PT-RS port 0 is associated with DMRS port 2 (jumping relationship).

Both the first port association relationship and the second port association relationship are used for indicating the association relationship between a single first reference signal port and a second reference signal port. Or, both the first port association relationship and the second port association relationship are used for indicating the association relationship between the dual first reference signal ports and the second reference signal ports.

In step 1108: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

To sum up, the method provided in this embodiment can simultaneously configure the association relationship between the first reference signal port and the second reference signal port for the first TRP through the third indication field, and can configure the association relationship between the first reference signal port and the second reference signal port for the second TRP through the first port association relationship and the first predefined relationship. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

(3) Using one indication field to indicate the port association relationships corresponding to two TRPs respectively. It can be divided into two cases of independent indication and joint indication, and each case is divided into two cases of single PT-RS port and dual PT-RS ports, so there are four cases in total.

The first type: independent indication, single PT-RS port.

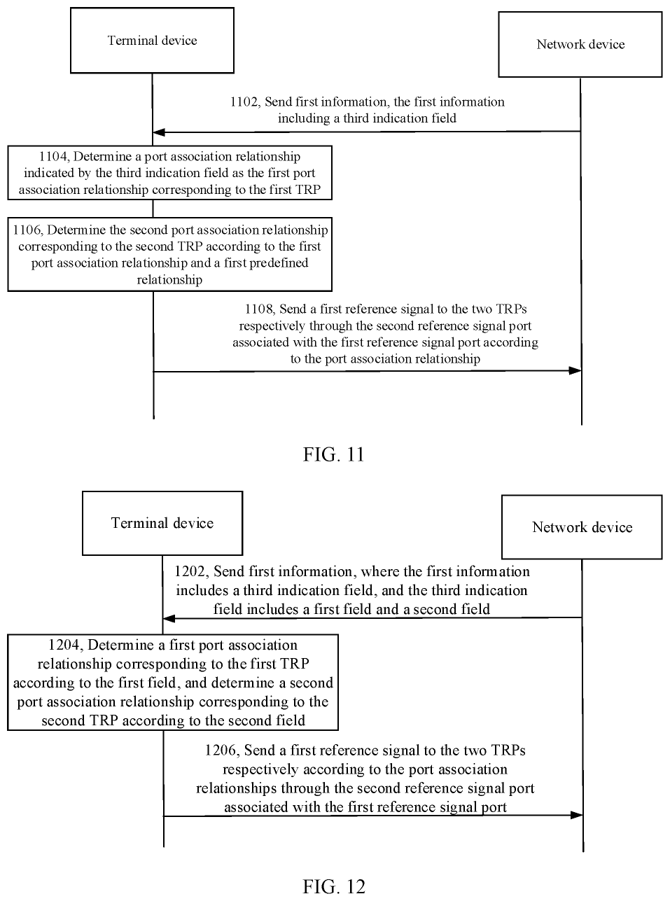

FIG. 12 shows a flowchart of a method for configuring a reference signal provided by an embodiment of the present application. FIG. 12 exemplifies that the method is applied to the communication system shown in FIG. 6. The method includes the following steps.

In step 1202: the network device sends first information to the terminal device, where the first information includes a third indication field, and the third indication field includes a first field and a second field.

The third indication field is used for determining the first port association relationship corresponding to the first TRP and the second port association relationship corresponding to the second TRP. Optionally, the first information is DCI. The first field and the second field are fields configured in the third indication field.

In step 1204: the terminal device determines the first port association relationship corresponding to the first TRP according to the first field, and determines the second port association relationship corresponding to the second TRP according to the second field.

Both the first TRP and the second TRP correspond to one first reference signal port. The second reference signal ports include a first group of second reference signal ports and a second group of second reference signal ports. Optionally, the first field is the MSB in the third indication field, and the second field is the LSB in the third indication field. According to the first field (MSB), the terminal device can determine the association relationship between the first reference signal port (PT-RS port 0) corresponding to the first TRP and one second reference signal port in the first group of second reference signal ports. According to the second field (LSB), the terminal device can determine the association relationship between the first reference signal port (PT-RS port 0) corresponding to the second TRP and one second reference signal port in the second group of second reference signal ports.

In step 1206: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

To sum up, the method provided in this embodiment can configure the association relationships between the first reference signal port and the second reference signal port for multi-TRP through the first field and the second field in the third indication field. One reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

The second type: joint indication, single PT-RS port.

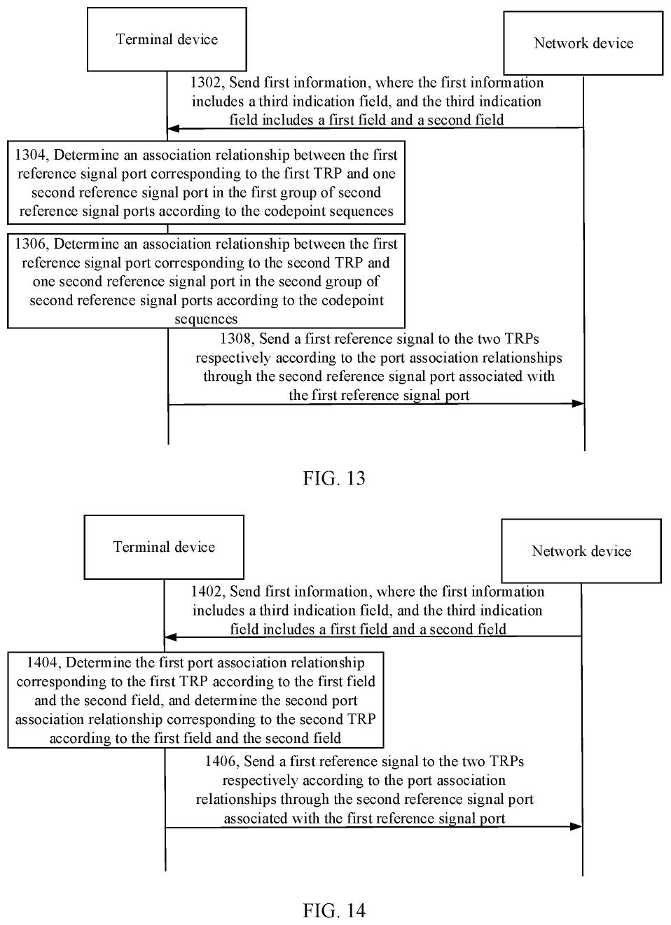

FIG. 13 shows a flowchart of a method for configuring a reference signal provided by an embodiment of the present application. FIG. 13 exemplifies that the method is applied to the communication system shown in FIG. 6. The method includes the following steps.

In step 1302: the network device sends first information to the terminal device, where the first information includes a third indication field, and the third indication field includes a first field and a second field.

The first field and the second field serve as a set of codepoint sequences to indicate the port corresponding relationships corresponding to the two TRPs. The third indication field is used for determining the first port association relationship corresponding to the first TRP and the second port association relationship corresponding to the second TRP. Optionally, the first information is DCI. The first field and the second field are fields configured in the third indication field.

Both the first TRP and the second TRP correspond to one first reference signal port, and the second reference signal port includes a first group of second reference signal ports and a second group of second reference signal ports.

In step 1304: the terminal device determines the association relationship between the first reference signal port corresponding to the first TRP and one second reference signal port in the first group of second reference signal ports according to the codepoint sequences.

In step 1306: the terminal device determines the association relationship between the first reference signal port corresponding to the second TRP and one second reference signal port in the second group of second reference signal ports according to the codepoint sequences.

The first field and the second field serve as a set of codepoint sequences, so the first field and the second field exist in the codepoint sequences. Table 3 shows the relationship between the codepoints and the indicated port associations in the case of single PT-RS port.

TABLE 3

| Codepoint | First TRP | Second TRP |
|---|---|---|
| 00 | 0 | 0 |
| 01 | 0 | 1 |
| 10 | 1 | 0 |
| 11 | 1 | 1 |

As shown in Table 3, the terminal device can determine the association relationship between PT-RS port 0 corresponding to the first TRP and one DMRS port in the first group of DMRS ports according to the first codepoint (first field). The terminal device can determine the association relationship between PT-RS port 0 corresponding to the second TRP and one DMRS port in the second group of DMRS ports according to the second codepoint (the second field). For example, when the codepoint is 00, the terminal device determines that PT-RS port 0 corresponding to the first TRP is associated with the first DMRS port in the first group of DMRS ports, and PT-RS port 0 corresponding to the second TRP is associated with the first DMRS port in the second group of DMRS ports. When the codepoint is 01, the terminal device determines that PT-RS port 0 corresponding to the first TRP is associated with the first DMRS port in the first group of DMRS ports, and PT-RS port 0 corresponding to the second TRP is associated with the second DMRS port in the second group of DMRS ports. The group of DMRS ports corresponding to PT-RS port 0 in each TRP is configured or predefined.

In step 1308: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

To sum up, the method provided by this embodiment can implement the configuration of the association relationships between the first reference signal port and the second reference signal port for multi-TRP respectively through the codepoint sequence in the third indication field. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

The third type: independent indication, dual PT-RS ports.

FIG. 14 shows a flowchart of a method for configuring a reference signal provided by an embodiment of the present application. FIG. 14 exemplifies that the method is applied to the communication system shown in FIG. 6. The method includes the following steps.

In step 1402: the network device sends first information to the terminal device, where the first information includes a third indication field, and the third indication field includes a first field and a second field.

The third indication field is used for determining the first port association relationship corresponding to the first TRP and the second port association relationship corresponding to the second TRP. Optionally, the first information is DCI. The first field and the second field are fields configured in the third indication field.

In step 1404: the terminal device determines the first port association relationship corresponding to the first TRP according to the first field and the second field, and determines the second port association relationship corresponding to the second TRP according to the first field and the second field.

The first reference signal port corresponding to the first TRP and the first reference signal port corresponding to the second TRP both include the first reference signal port 0 and the first reference signal port 1, and the second reference signal ports include the first group of second reference signal ports and the second group of second reference signal ports. Optionally, the first field is the MSB in the third indication field, and the second field is the LSB in the third indication field. According to the first field (MSB), the terminal device can determine the association relationship between the first reference signal port 0 (PT-RS port 0) corresponding to the first TRP and one second reference signal port in the first group of second reference signal ports, and according to the second field (LSB), the terminal device can determine the association relationship between the first reference signal port 1 (PT-RS port 1) corresponding to the first TRP and one second reference signal port in the second group of second reference signal ports. In addition, the terminal device can also determine the association relationship between the first reference signal port 0 and the first reference signal port 1 corresponding to the second TRP and the second reference signal port based on the above rule. That is, the terminal device can determine the association relationship between PT-RS port 0 corresponding to each TRP and the DMRS port according to the MSB, and the terminal device can determine the association relationship between the PT-RS port 1 corresponding to each TRP and the DMRS port according to the LSB.

In addition, the terminal device can also determine the port association relationship indicated by the first field and the second field as the first port association relationship corresponding to the first TRP, and according to the first port association relationship and the second predefined relationship, determines the second port association relationship corresponding to the second TRP. The first port association relationship is different from the second port association relationship. After determining the first port association relationship, the terminal device uses the first port association relationship as a reference, and can determine the second port association relationship according to the second predefined relationship. The second predefined relationship includes cycling and other patterns. For example, the terminal device determines that the PT-RS port 0 corresponding to the first TRP is associated with the first DMRS port in the first group of DMRS ports according to the MSB, and determines that the PT-RS port 1 corresponding to the first TRP is associated with the first DMRS port in the second group of DMRS ports according to the LSB. Then, based on the cycling, the terminal device determines that the PT-RS port 0 corresponding to the second TRP is associated with the second DMRS port in the first group of DMRS ports, and determines that the PT-RS port 1 corresponding to the second TRP is associated with the second DMRS port in the second group of DMRS ports.

In step 1406: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

To sum up, the method provided in this embodiment can configure the association relationships between two first reference signal ports and the second reference signal port for multi-TRP through the first field and the second field in the third indication field. The first reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

The fourth type: joint indication, dual PT-RS ports.

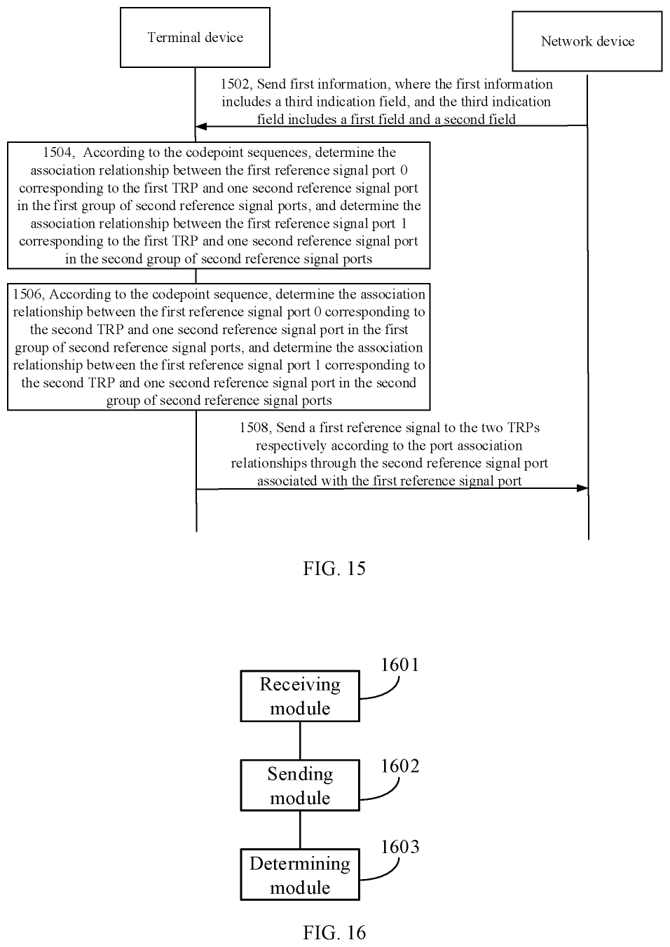

FIG. 15 shows a flowchart of a method for configuring a reference signal provided by an embodiment of the present application. FIG. 15 exemplifies that the method is applied to the communication system shown in FIG. 6. The method includes the following steps.

In step 1502: the network device sends first information to the terminal device, where the first information includes a third indication field, and the third indication field includes a first field and a second field.

The third indication field is used for determining the first port association relationship corresponding to the first TRP and the second port association relationship corresponding to the second TRP. The first field and the second field serve as a set of codepoint sequences to indicate the port corresponding relationships corresponding to two TRPs. Optionally, the first information is DCI. The first field and the second field are fields configured in the third indication field.

The first reference signal port corresponding to the first TRP and the first reference signal port corresponding to the second TRP both include the first reference signal port 0 and the first reference signal port 1, and the second reference signal ports include the first group of second reference signal ports and the second group of second reference signal port.

It should be noted that the indication fields (the first indication field, the second indication field, and the third indication field) in the present application refer to indication fields used for indicating port relationships.

In step 1504: according to the codepoint sequences, the terminal device determines the association relationship between the first reference signal port 0 corresponding to the first TRP and one second reference signal port in the first group of second reference signal ports, and determines the association relationship between the first reference signal port 1 corresponding to the first TRP and one second reference signal port in the second group of second reference signal ports.

In step 1506: according to the codepoint sequence, the terminal device determines the association relationship between the first reference signal port 0 corresponding to the second TRP and one second reference signal port in the first group of second reference signal ports, and determines the association relationship between the first reference signal port 1 corresponding to the second TRP and one second reference signal port in the second group of second reference signal ports.

The first field and the second field serve as a set of codepoint sequences, so the first field and the second field exist in the codepoint sequences. According to the first codepoint (first field), the terminal device can determine the association relationship between PT-RS port 0 corresponding to the first TRP and one DMRS port in the first group of DMRS ports. According to the second codepoint (the second field), the terminal device can determine the association relationship between the PT-RS port 1 corresponding to the first TRP and one DMRS port in the second group of DMRS ports. In addition, the terminal device can also determine the association relationships between PT-RS port 0 and PT-RS port 1 corresponding to the second TRP and the DMRS port in the above manner. For example, when the codepoint is 00, the terminal device determines that the PT-RS port 0 corresponding to the first TRP is associated with the first DMRS port in the first group of DMRS ports, and the PT-RS port 1 corresponding to the first TRP is associated with the first DMRS port in the second group of DMRS ports. The terminal device may also determine that the PT-RS port 0 corresponding to the second TRP is associated with the first DMRS port in the first group of DMRS ports, and the PT-RS port 1 corresponding to the second TRP is associated with the first DMRS port in the second group of DMRS ports.

In addition, the terminal device can also determine the port association relationship indicated by the first field and the second field as the first port association relationship corresponding to the first TRP, and according to the first port association relationship and a third predefined relationship, determines the second port association relationship corresponding to the second TRP. The first port association relationship is different from the second port association relationship.

In step 1508: the terminal device sends a first reference signal to the two TRPs respectively according to the port association relationships.

When the terminal device transmits the PT-RS to the first TRP in uplink, it may use the DMRS port associated with the PT-RS port corresponding to the first TRP. When the terminal device transmits the PT-RS to the second TRP in uplink, it may use the DMRS port associated with the PT-RS port corresponding to the second TRP.

Optionally, in addition to reporting to the network device whether it supports the capability of being configured with the second indication field, the terminal device may also report whether it supports the capability of being configured with the first indication field, and the network device may accordingly configure the terminal device with the first information including the first indication field. Alternatively, if reporting whether supporting the capability of being configured with the third indication field, the network device may correspondingly configure the first information including the third indication field for the terminal device. Alternatively, if reporting that it supports the capability of being configured with two indication fields, the network device may correspondingly configure the first information including the first indication field and the second indication field for the terminal device.

To sum up, the method provided in this embodiment can simultaneously configure the association relationships between two first reference signal ports and the second reference signal port for multi-TRP through the codepoint sequences in the third indication field. The reference signal can be a PT-RS, and the second reference signal can be a DMRS. The port association relationships configured for multi-TRP can achieve a trade-off between DCI overhead and PT-RS performance to a certain extent, provide more scheduling flexibility for the network, and ensure the overall optimal system performance.

FIG. 16 shows a structural block diagram of an apparatus for configuring a reference signal provided by some embodiments of the present application. The apparatus can be implemented as a terminal device, or can be implemented as a part of the terminal device. The apparatus includes:
a receiving module 1601, configured to receive first information sent by the network device, the first information is used for indicating port association relationships corresponding to two TRPs, and the port association relationship is used for reflecting an association relationship between a first reference signal port and a second reference signal port.

In an optional design, the two TRPs include a first TRP and a second TRP, and the first information includes a first indication field and a second indication field.

The first indication field is used for indicating the first port association relationship corresponding to the first TRP.

The second indication field is used for indicating the second port association relationship corresponding to the second TRP.

In an optional design, the apparatus further includes:
a sending module 1602, configured to report a terminal capability to the network device, where the terminal capability is used for indicating whether the terminal device supports a capability of being configured with the second indication field.

In an optional design, the first information is sent by the network device when the terminal device supports the capability of being configured with the second indication field.

In an optional design, the receiving module 1601 is configured to receive second information sent by the network device, where the second information is used for indicating that the first information includes two indication fields.

In an optional design, the two TRPs include a first TRP and a second TRP, the first information includes a third indication field, and the third indication field is used for indicating the port corresponding relationships corresponding to the two TRPs using the same indication field. The apparatus further includes:
a determining module 1603, configured to determine the first port association relationship corresponding to the first TRP and the second port association relationship corresponding to the second TRP according to the third indication field.

In an optional design, the determining module 1603 is configured to:
determine a port association relationship indicated by the third indication field as the first port association relationship corresponding to the first TRP and the second port association relationship corresponding to the second TRP.

The first port association relationship is the same as the second port association relationship.

In an optional design, the determining module 1603 is configured to:
determine the port association relationship indicated by the third indication field as the first port association relationship corresponding to the first TRP.

According to the first port association relationship and the first predefined relationship, the second port association relationship corresponding to the second TRP is determined.

The first port association relationship is different from the second port association relationship.

In an optional design, the third indication field includes a first field and a second field. The determining module 1603 is configured to:
determine the first port association relationship corresponding to the first TRP according to the first field, and determine the second port association relationship corresponding to the second TRP according to the second field;
or,
determine the first port association relationship corresponding to the first TRP according to the first field and the second field, and determine the second port association relationship corresponding to the second TRP according to the first field and the second field.

In an optional design, there is one first reference signal port corresponding to the first TRP and the second TRP, and the second reference signal port includes a first group of second reference signal ports and a second group of second reference signal ports. The determining module 1603 is configured to:
according to the first field, determine an association relationship between the first reference signal port corresponding to the first TRP and one second reference signal port in the first group of second reference signal ports;
according to the second field, determine an association relationship between the first reference signal port corresponding to the second TRP and one second reference signal port in the second group of second reference signal ports.

In an optional design, the first reference signal port corresponding to the first TRP and the first reference signal port corresponding to the second TRP both include the first reference signal port 0 and the first reference signal port 1, and the second reference signal ports include the first group of second reference signal ports signal ports and the second group of second reference signal ports. The determining module 1603 is configured to:
according to the first field, determine the association relationship between the first reference signal port 0 corresponding to the first TRP and one second reference signal port in the first group of second reference signal ports, and according to the second field, determine the association relationship between the first reference signal port 1 corresponding to the first TRP and one second reference signal port in the second group of second reference signal ports;
according to the first field, determine the association relationship between the first reference signal port 0 corresponding to the second TRP and one second reference signal port in the first group of second reference signal ports, and according to the second field, determine the association relationship between the first reference signal port 1 corresponding to the second TRP and one second reference signal port in the second group of second reference signal ports.

In an optional design, the third indication field includes a first field and a second field, and the first field and the second field serve as a set of codepoint sequences to indicate the port corresponding relationships corresponding to the two TRPs. The first TRP and the second TRP both corresponds to one first reference signal port, and the second reference signal ports include a first group of second reference signal ports and a second group of second reference signal ports. The determining module 1603 is configured to:
according to the codepoint sequences, determine an association relationship between the first reference signal port corresponding to the first TRP and one second reference signal port in the first group of second reference signal ports;
according to the codepoint sequences, determine an association relationship between the first reference signal port corresponding to the second TRP and one second reference signal port in the second group of second reference signal ports.

In an optional design, the third indication field includes a first field and a second field, and the first field and the second field serve as a set of codepoint sequences to indicate the port corresponding relationships corresponding to two TRPs. The first reference signal port corresponding to the first TRP and the first reference signal port corresponding to the second TRP both include a first reference signal port 0 and a first reference signal port 1, and the second reference signal ports include a first group of second reference signal ports and a second group of second reference signal ports. The determining module 1603 is configured to:
according to the codepoint sequences, determine the association relationship between the first reference signal port 0 corresponding to the first TRP and one second reference signal port in the first group of second reference signal ports, and determine an association relationship between the first reference signal port 1 corresponding to the first TRP and one second reference signal port in the second group of second reference signal ports;
according to the codepoint sequences, determine the association relationship between the first reference signal port 0 corresponding to the second TRP and one second reference signal port in the first group of second reference signal ports, and determine the association relationship between the first reference signal port 1 corresponding to the second TRP and one second reference signal port in the second group of second reference signal ports.

In an optional design, the determining module 1603 is configured to:
determine the port association relationship indicated by the first field and the second field as the first port association relationship corresponding to the first TRP;
according to the first port association relationship and the second predefined relationship, determine the second port association relationship corresponding to the second TRP.

The first port association relationship is different from the second port association relationship.

In an optional design, each TRP corresponds to one or two first reference signal ports.

In an optional design, the first reference signal is PT-RS, and the second reference signal is DMRS.

In an optional design, the first information is DCI.

In an optional design, the second information is RRC information.

In an optional design, the sending module 1601 is configured to:
according to the port association relationships, send a first reference signal to the two TRPs respectively.

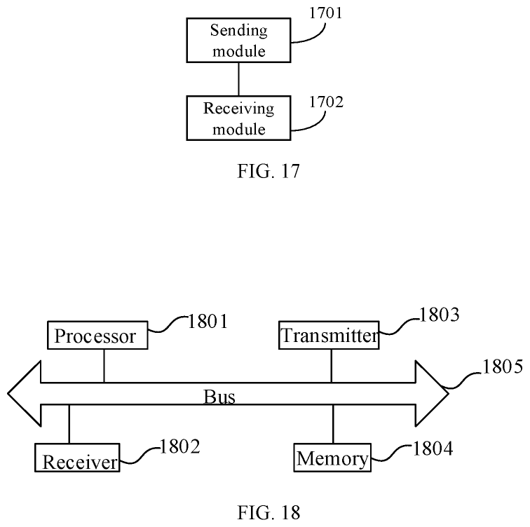

FIG. 17 shows a structural block diagram of an apparatus for configuring a reference signal provided by some embodiments of the present application. The apparatus can be implemented as a network device, or can be implemented as a part of the network device. The apparatus includes:
a sending module 1701, configured to send first information to the terminal device, where the first information is used for indicating port association relationships corresponding to two TRPs, and the port association relationship is used for reflecting an association relationship between a first reference signal port and a second reference signal port.

In an optional design, the two TRPs include a first TRP and a second TRP, and the first information includes a first indication field and a second indication field.

The first indication field is used for indicating a first port association relationship corresponding to the first TRP.

The second indication field is used for indicating a second port association relationship corresponding to the second TRP.

In an optional design, the apparatus further includes:
a receiving module 1702, configured to receive a terminal capability reported by the terminal device, where the terminal capability is used for indicating whether the terminal device supports a capability of being configured with the second indication field.

In an optional design, the sending module 1701 is configured to:

In response to the ability of the terminal device to support the configured second indication field, the first information is sent to the terminal device.

In an optional design, the sending module 1701 is configured to:
send second information to the terminal device, where the second information is used for indicating that the first information includes two indication fields.

In an optional design, the two TRPs include a first TRP and a second TRP, the first information includes a third indication field, and the third indication field is used for indicating port corresponding relationships corresponding to the two TRPs using the same indication field.

The third indication field is used for indicating the first port association relationship corresponding to the first TRP and the second port association relationship corresponding to the second TRP.

In an optional design, the port association relationship indicated by the third indication field is used for indicating the first port association relationship corresponding to the first TRP and the second port association relationship corresponding to the second TRP.

The first port association relationship is the same as the second port association relationship.

In an optional design, the port association relationship indicated by the third indication field is used for indicating the first port association relationship corresponding to the first TRP. The first port association relationship and a first predefined relationship are used for indicating the second port association relationship corresponding to the second TRP.

The first port association relationship is different from the second port association relationship.

In an optional design, the third indication field includes a first field and a second field.

The first field is used for indicating the first port association relationship corresponding to the first TRP, and the second field is used for indicating the second port association relationship corresponding to the second TRP,
or,
the first field and the second field are used for indicating the first port association relationship corresponding to the first TRP, and the first field and the second field are also used for indicating the second port association relationship corresponding to the second TRP.

In an optional design, there is one first reference signal port corresponding to the first TRP and the second TRP, and the second reference signal port includes a first group of second reference signal ports and a second group of second reference signal ports.

The first field is used for indicating an association relationship between the first reference signal port corresponding to the first TRP and one second reference signal port in the first group of second reference signal ports.

The second field is used for indicating an association relationship between the first reference signal port corresponding to the second TRP and one second reference signal port in the second group of second reference signal ports.

In an optional design, the first reference signal port corresponding to the first TRP and the first reference signal port corresponding to the second TRP both include a first reference signal port 0 and a first reference signal port 1, and the second reference signal ports include a first group of second reference signal ports and a second group of second reference signal ports.

The first field is used for indicating the association relationship between the first reference signal port 0 corresponding to the first TRP and one second reference signal port in the first group of second reference signal ports, and the second field is used for indicating the association relationship between the first reference signal port 1 corresponding to the first TRP and one second reference signal port in the second group of second reference signal ports.

The first field is also used for indicating the association relationship between the first reference signal port 0 corresponding to the second TRP and one second reference signal port in the first group of second reference signal ports, and the second field is also used for indicating the association relationship between the first reference signal port 1 corresponding to the second TRP and one second reference signal port in the second group of second reference signal ports.

In an optional design, the third indication field includes a first field and a second field, and the first field and the second field serve as a set of codepoint sequences to indicate the port corresponding relationships corresponding to two TRPs. The first TRP and the second TRP both correspond to one first reference signal port, and the second reference signal ports include a first group of second reference signal ports and a second group of second reference signal ports.

The codepoint sequence is used for indicating the association relationship between the first reference signal port corresponding to the first TRP and one second reference signal port in the first group of second reference signal ports.

The codepoint sequence is further used for indicating the association relationship between the first reference signal port corresponding to the second TRP and one second reference signal port in the second group of second reference signal ports.

In an optional design, the third indication field includes a first field and a second field, and the first field and the second field serve as a set of codepoint sequences to indicate the port corresponding relationships corresponding to the two TRPs. The first reference signal port corresponding to the first TRP and the first reference signal port corresponding to the second TRP both include a first reference signal port 0 and a first reference signal port 1, and the second reference signal ports include a first group of second reference signal ports and a second group of second reference signal ports.

The codepoint sequence is used for indicating the association relationship between the first reference signal port 0 corresponding to the first TRP and one second reference signal port in the first group of second reference signal ports, and is also used for indicating the association relationship between the first reference signal port 1 corresponding to the first TRP and one second reference signal port in the second group of second reference signal ports.

The codepoint sequence is also used for indicating the association relationship between the first reference signal port 0 corresponding to the second TRP and one second reference signal port in the first group of second reference signal ports, and is also used for indicating the association relationship between the first reference signal port 1 corresponding to the second TRP and one second reference signal port in the second group of second reference signal ports.

In an optional design, the port association relationship indicated by the first field and the second field is used for indicating the first port association relationship corresponding to the first TRP.

The first port association relationship and the second predefined relationship are used for indicating the second port association relationship corresponding to the second TRP.

The first port association relationship is different from the second port association relationship.

In an optional design, each TRP corresponds to one or two first reference signal ports.

In an optional design, the first reference signal is PT-RS, and the second reference signal is DMRS.

In an optional design, the first information is DCI.

In an optional design, the second information is RRC information.

In an optional design, the receiving module 1702 is configured to:

receive a first reference signal sent by the terminal device respectively through the two TRPs according to the port association relationships.

FIG. 18 shows a schematic structural diagram of a communication device (terminal device or network device) provided by some embodiments of the present application. The communication device includes: a processor 1801, a receiver 1802, a transmitter 1803, a memory 1804 and a bus 1805.

The processor 1801 includes one or more processing cores, and the processor 1801 executes various functional applications and information processing by running software programs and modules.

The receiver 1802 and the transmitter 1803 can be realized as one communication component, and the communication component can be one communication chip.

The memory 1804 is connected to the processor 1801 through the bus 1805.

The memory 1804 may be used to store at least one instruction, and the processor 1801 is used to execute the at least one instruction, so as to implement various steps in the foregoing method embodiments.

In addition, the memory 1804 may be implemented by using any type of volatile or non-volatile memory devices or a combination thereof. The volatile or non-volatile memory devices include but not limited to: a magnetic disk or an optical disk, an Electrically-Erasable Programmable Read Only Memory (EEPROM), an Erasable Programmable Read Only Memory (EPROM), a Static Random Access Memory (SRAM), a Read-Only Memory (ROM), a magnetic memory, a flash memory, a Programmable Read-Only Memory (PROM).

When the communication device is implemented as a terminal device, the processor and the transceiver in the communication device involved in the embodiments of the present application may execute the steps performed by the communication device in the method shown in any of the above method embodiments, which are not elaborated here.

In a possible implementation manner, when the communication device is implemented as a terminal device,
the transceiver is configured to receive first information sent by the network device, where the first information is used for indicating port association relationships corresponding to two TRPs, and the port association relationship is used for reflecting an association relationship between a first reference signal port and a second reference signal port.

When the communication device is implemented as a network device, the processor and the transceiver in the communication device involved in the embodiments of the present application can perform the steps performed by the network device in any of the above-mentioned methods, which are not elaborated here.

In a possible implementation manner, when the communication device is implemented as a network device,
the transceiver is configured to send first information to the terminal device, where the first information is used for indicating port association relationships corresponding to two TRPs, and the port association relationship is used for reflecting an association relationship between a first reference signal port and a second reference signal port.

In some embodiments, a non-transitory computer-readable storage medium is also provided, the non-transitory computer-readable storage medium stores at least one instruction, at least one segment of program, a code set or an instruction set, the at least one instruction, the at least one segment of program, the code set or the instruction set is loaded and executed by the processor to implement the method for configuring a reference signal performed by the communication device provided by the above method embodiments.

In some embodiments, a chip is also provided, the chip includes a programmable logic circuit and/or program instructions, and when the chip is run on a computer device, it is used to implement the method for configuring a reference signal described in the above aspects.

In some embodiments, there is also provided a computer program product, which, when running on a processor of a computer device, causes the computer device to execute the method for configuring a reference signal described in the above aspects.

Those of ordinary skill in the art can understand that all or part of the steps for implementing the above embodiments can be completed by hardware, or can be completed by instructing related hardware through a program, and the program can be stored in a non-transitory computer-readable storage medium. The storage medium mentioned may be a read-only memory, a magnetic disk or an optical disk, or the like.

The above are only optional embodiments of the present application, and are not intended to limit the present application. Any modifications, equivalent replacements, improvements, etc. made within the spirit and principles of the present application shall be included in the protection scope of the present application.

1. A method for configuring a reference signal, wherein the method comprises:
receiving, by a terminal device, first information sent by a network device, wherein the first information is configured for indicating port association relationships corresponding to two Transmit-Receive Points (TRPs), and a port association relationship is configured for reflecting an association relationship between a first reference signal port and a second reference signal port.

2. The method according to claim 1, wherein the two TRPs comprises a first TRP and a second TRP, and the first information comprises a first indication field and a second indication field, wherein
the first indication field is configured for indicating a first port association relationship corresponding to the first TRP; and
the second indication field is configured for indicating a second port association relationship corresponding to the second TRP.

3. The method according to claim 2, further comprising:
reporting, by the terminal device, a terminal capability to the network device, wherein the terminal capability is configured for indicating whether the terminal device supports a capability of being configured with the second indication field.

4. The method according to claim 2, wherein the first information is sent by the network device in response to determining that the terminal device supports the capability of being configured with the second indication field.

5. The method according to claim 2, further comprising:
receiving, by the terminal device, second information sent by the network device, wherein the second information is configured for indicating that the first information comprises two indication fields.

6. The method according to claim 1, wherein the two TRPs comprise a first TRP and a second TRP, the first information comprises a third indication field, wherein the third indication field is configured for indicating port association relationships corresponding to the two TRPs by a same indication field;
wherein the method further comprises:
determining a first port association relationship corresponding to the first TRP and a second port association relationship corresponding to the second TRP according to the third indication field.

7. The method according to claim 6, wherein determining the first port association relationship corresponding to the first TRP and the second port association relationship corresponding to the second TRP according to the third indication field comprises:
determining a port association relationship indicated by the third indication field as the first port association relationship corresponding to the first TRP and the second port association relationship corresponding to the second TRP,
wherein the first port association relationship is the same as the second port association relationship.

8. The method according to claim 6, wherein determining the first port association relationship corresponding to the first TRP and the second port association relationship corresponding to the second TRP according to the third indication field comprises:
determining a port association relationship indicated by the third indication field as the first port association relationship corresponding to the first TRP; and
determining the second port association relationship corresponding to the second TRP according to the first port association relationship and a first predefined relationship,
wherein the first port association relationship is different from the second port association relationship.

9. The method according to claim 6, wherein the third indication field comprises a first field and a second field; and
wherein determining the first port association relationship corresponding to the first TRP and the second port association relationship corresponding to the second TRP according to the third indication field comprises:
determining the first port association relationship corresponding to the first TRP according to the first field, and determining the second port association relationship corresponding to the second TRP according to the second field;
or
determining the first port association relationship corresponding to the first TRP according to the first field and the second field, and determining the second port association relationship corresponding to the second TRP according to the first field and the second field.

10. The method according to claim 9, wherein a number of the first reference signal port corresponding to the first TRP and a number of the first reference signal port corresponding to the second TRP are both 1, and the second reference signal port comprises a first group of second reference signal ports and a second group of second reference signal ports; and
wherein determining the first port association relationship corresponding to the first TRP according to the first field, and determining the second port association relationship corresponding to the second TRP according to the second field comprises:
determining a first association relationship between the first reference signal port corresponding to the first TRP and one second reference signal port in the first group of second reference signal ports according to the first field; and
determining a second association relationship between the first reference signal port corresponding to the second TRP and one second reference signal port in the second group of second reference signal ports according to the second field.

11. The method according to claim 9, wherein the first reference signal port corresponding to the first TRP and the first reference signal port corresponding to the second TRP both comprise a first reference signal port 0 and a first reference signal port 1, and the second reference signal port comprises a first group of second reference signal ports and a second group of second reference signal ports; and
wherein determining the first port association relationship corresponding to the first TRP according to the first field and the second field, and determining the second port association relationship corresponding to the second TRP according to the first field and the second field, comprises:
determining a first association relationship between the first reference signal port 0 corresponding to the first TRP and one second reference signal port in the first group of second reference signal ports according to the first field, and determining a second association relationship between the first reference signal port 1 corresponding to the first TRP and one second reference signal port in the second group of second reference signal ports according to the second field;
determining a third association relationship between the first reference signal port 0 corresponding to the second TRP and one second reference signal port in the first group of second reference signal ports according to the first field, and determining a fourth association relationship between the first reference signal port 1 corresponding to the second TRP and one second reference signal port in the second group of second reference signal ports according to the second field.

12. The method according to claim 9, wherein the first field and the second field serve as a set of codepoint sequences to indicate port association relationships corresponding to the two TRPs, a number of the first reference signal port corresponding to the first TRP and a number of the first reference signal port corresponding to the second TRP are both 1, and the second reference signal port comprises a first group of second reference signal ports and a second group of second reference signal ports; and
wherein the method further comprises:
determining a first association relationship between the first reference signal port corresponding to the first TRP and one second reference signal port in the first group of second reference signal ports according to the codepoint sequences; and
determining a second association relationship between the first reference signal port corresponding to the second TRP and one second reference signal port in the second group of second reference signal ports according to the codepoint sequences.

13. The method according to claim 9, wherein the first field and the second field serve as a set of codepoint sequences to indicate port association relationships corresponding to the two TRPs, the first reference signal port corresponding to the first TRP and the first reference signal port corresponding to the second TRP both comprise a first reference signal port 0 and a first reference signal port 1, and the second reference signal port comprises a first group of second reference signal ports and a second group of second reference signal ports; and
wherein the method further comprises:
according to the codepoint sequences, determining a first association relationship between the first reference signal port 0 corresponding to the first TRP and one second reference signal port in the first group of second reference signal ports, and determining a second association relationship between the first reference signal port 1 corresponding to the first TRP and one second reference signal port in the second group of second reference signal ports; and
according to the codepoint sequences, determining a third association relationship between the first reference signal port 0 corresponding to the second TRP and one second reference signal port in the first group of second reference signal ports, and determining a fourth association relationship between the first reference signal port 1 corresponding to the second TRP and one second reference signal port in the second group of second reference signal ports.

14. The method according to claim 9, wherein determining the first port association relationship corresponding to the first TRP according to the first field and the second field, and determining the second port association relationship corresponding to the second TRP according to the first field and the second field comprises:
determining a port association relationship indicated by the first field and the second field as the first port association relationship corresponding to the first TRP; and
determining the second port association relationship corresponding to the second TRP according to the first port association relationship and a second predefined relationship,
wherein the first port association relationship is different from the second port association relationship.

15-19. (canceled)

20. A method for configuring a reference signal, wherein the method comprises:
sending, by a network device, first information to a terminal device, wherein the first information is configured for indicating port association relationships corresponding to two TRPs, and a port association relationship is configured for reflecting an association relationship between a first reference signal port and a second reference signal port.

21. The method according to claim 20, wherein the two TRPs comprise a first TRP and a second TRP, and the first information comprises a first indication field and a second indication field; wherein
the first indication field is configured for indicating a first port association relationship corresponding to the first TRP;
the second indication field is configured for indicating a second port association relationship corresponding to the second TRP.

22. The method according to claim 21, further comprising:
receiving, by the network device, a terminal capability reported by the terminal device, wherein the terminal capability is configured for indicating whether the terminal device supports a capability of being configured with the second indication field.

23. The method according to claim 21, wherein sending, by the network device, the first information to the terminal device comprises:
in response to determining that the terminal device supports the capability of being configured with the second indication field, sending, by the network device, the first information to the terminal device.

24-40. (canceled)

41. A terminal device, wherein the terminal device comprises: a processor and a transceiver connected to the processor; wherein
the transceiver is configured to receive first information sent by a network device, wherein the first information is configured for indicating port association relationships corresponding to two TRPs, and a port association relationship is configured for reflecting an association relationship between a first reference signal port and a second reference signal port.

42. A network device, wherein the network device comprises: a processor and a transceiver connected to the processor; wherein
the transceiver is configured to implement the method for configuring a reference signal according to claim 20.

43-44. (canceled)
